(19) United States
(12) Patent Application Publication
(10) Pub. No.: US 2026/0121964 A1
(43) Pub. Date: Apr. 30, 2026

(54) VARIABLE ROUTING OF VEHICLE DATA TO EXTERNAL NETWORKS

(71) Applicant: Rivian IP Holdings, LLC, Irvine, CA (US)

(72) Inventor: Vamsi Krishna RAVULAPALLI, Dublin, CA (US)

(21) Appl. No.: 19/363,384

(22) Filed: Oct. 20, 2025

Related U.S. Application Data
(60) Provisional application No. 63/712,983, filed on Oct. 28, 2024.

(51) Int. Cl. H04L 45/02; H04W 4/48

(52) U.S. Cl. CPC H04L 45/02; H04W 4/48

(57) ABSTRACT

In an embodiment, a system for routing vehicle network traffic to external networks includes a first computer in a vehicle and a second computer in the vehicle. The first computer is operable to receive network traffic related to a software application executing in the vehicle, determine a category for the network traffic based on a traffic categorization policy, determine a virtual network port of a virtual network interface for the determined category, and transmit the network traffic, via the determined virtual network port, over an internal network connection in the vehicle. The second computer is communicably coupled to the first computer via the internal network connection and is operable to receive the network traffic, via the virtual network port, over the internal network connection, and route the network traffic to an external network based on the virtual network port.

### CROSS-REFERENCE TO RELATED APPLICATIONS

This application claims the benefit of priority of U.S. Provisional Patent Application Ser. No. 63/712,983 titled “VARIABLE ROUTING OF VEHICLE DATA TO EXTERNAL NETWORKS,” filed on Oct. 28, 2024, which is hereby incorporated by reference in its entirety as though fully and completely set forth herein.

### INTRODUCTION

The present disclosure relates to variable routing of vehicle data to external networks.

### SUMMARY

In an embodiment, a system for routing vehicle network traffic to external networks includes a first computer in a vehicle and a second computer in the vehicle. The first computer is operable to receive network traffic related to a software application executing in the vehicle, determine a category for the network traffic based on a traffic categorization policy, determine a virtual network port of a virtual network interface for the determined category, and transmit the network traffic, via the determined virtual network port, over an internal network connection in the vehicle. The second computer is communicably coupled to the first computer via the internal network connection and is operable to receive the network traffic, via the virtual network port, over the internal network connection, and route the network traffic to an external network based on the virtual network port.

In an embodiment, a method for routing vehicle network traffic to external networks includes receiving, at a first computer in a vehicle, network traffic related to a software application executing in the vehicle. The method also includes determining, at the first computer, a category for the network traffic based on a traffic categorization policy. The method also includes determining, at the first computer, a virtual network port of a virtual network interface for the determined category. The method also includes transmitting the network traffic, via the determined virtual network port, over an internal network connection in the vehicle. The method also includes, at a second computer in the vehicle, receiving the network traffic, via the virtual network port, over the internal network connection. The method also includes, at the second computer, routing the network traffic to an external network based on the virtual network port.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 illustrates a connectivity architecture for a vehicle.

FIG. 4 illustrates an example of a process for utilizing the connectivity architecture of FIG. 3.

### DETAILED DESCRIPTION

A vehicle can provide connectivity to one or more external networks, such as Wi-Fi and/or cellular networks, via various wireless radios therein. The connectivity can support various vehicle features, such as video streaming, music streaming, over-the-air (OTA) software updates, navigation, in-vehicle Wi-Fi hotspots, vehicle telemetry, etc.

In certain aspects, the vehicle can include radio control functionality that regulates, for example, the routing of network traffic to the external networks via the wireless radios mentioned above. In certain aspects, the vehicle's wireless radios and radio control functionality can be co-located in proximity to an antenna, for example, in or on a roof of the vehicle. Although this co-location can be technically advantageous with respect to radio functionality, it also typically results in the radio control functionality being physically segregated from applications that provide the vehicle features mentioned above. For example, the radio control functionality and the vehicle applications can reside, or be implemented on, separate hardware components, such as different electronic control units (ECUs) or other systems in the vehicle. The separate components can communicate, for example, via an internal wired and/or wireless network connection. In various aspects, this separation complicates certain modern networking capabilities, such as variable routing of the vehicle's network traffic to the external networks. It is technically difficult to differentiate the network traffic, and achieve variability in the routing based thereon, when the radio control functionality is performed on separate hardware within the vehicle.

In various approaches described herein, certain modern networking capabilities, such as variable routing of a vehicle's network traffic, can be achieved via one or more virtual interfaces within the vehicle. In certain aspects, the one or more virtual interfaces can operate based on a configurable set of network traffic categories. In certain aspects, the one or more virtual interfaces enable vehicle network traffic to be internally transmitted within the vehicle based on a category of the traffic and, thereafter, to be variably routed to external networks according to the category. Examples will be described relative to the Drawings.

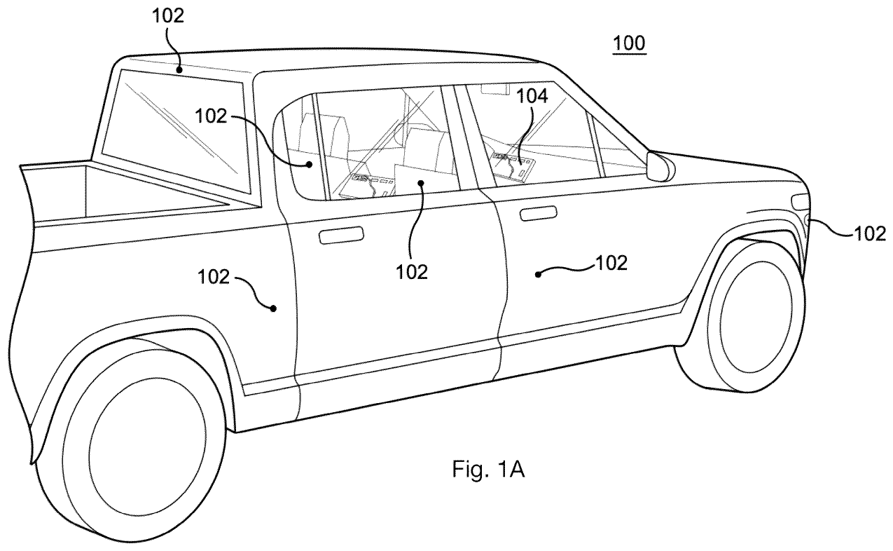

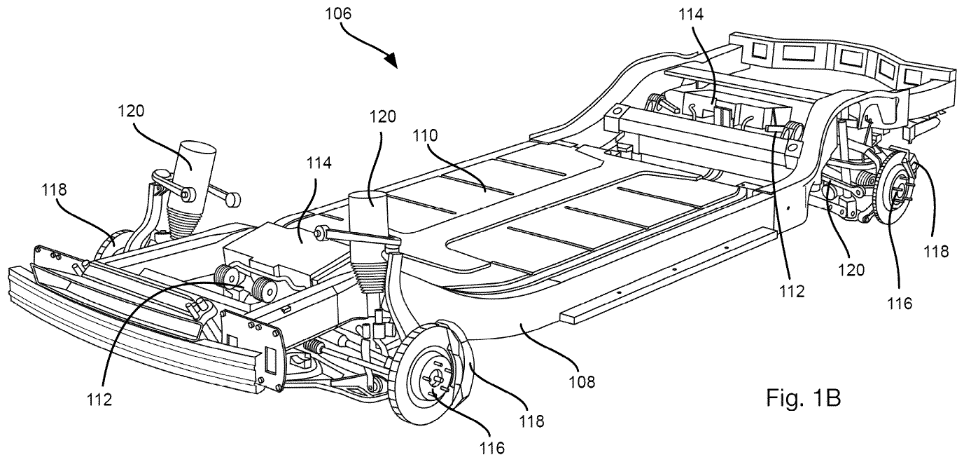

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

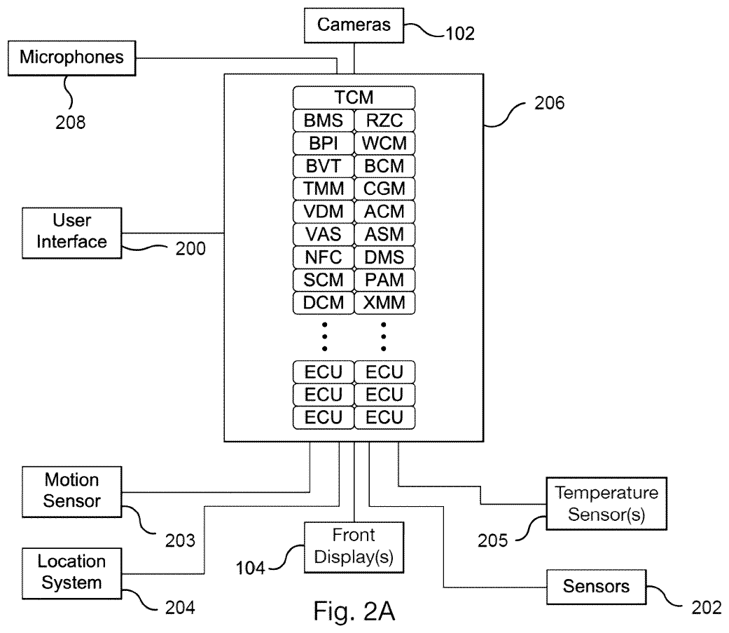

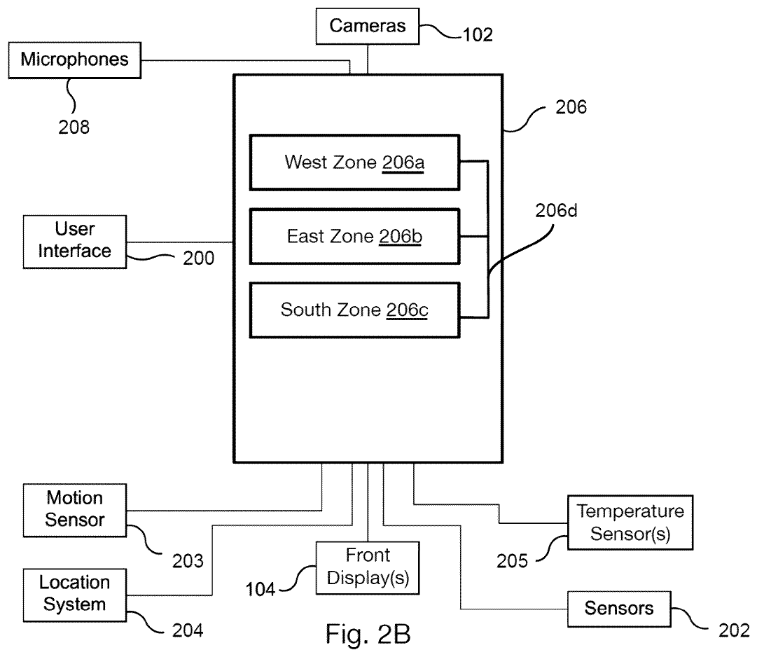

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

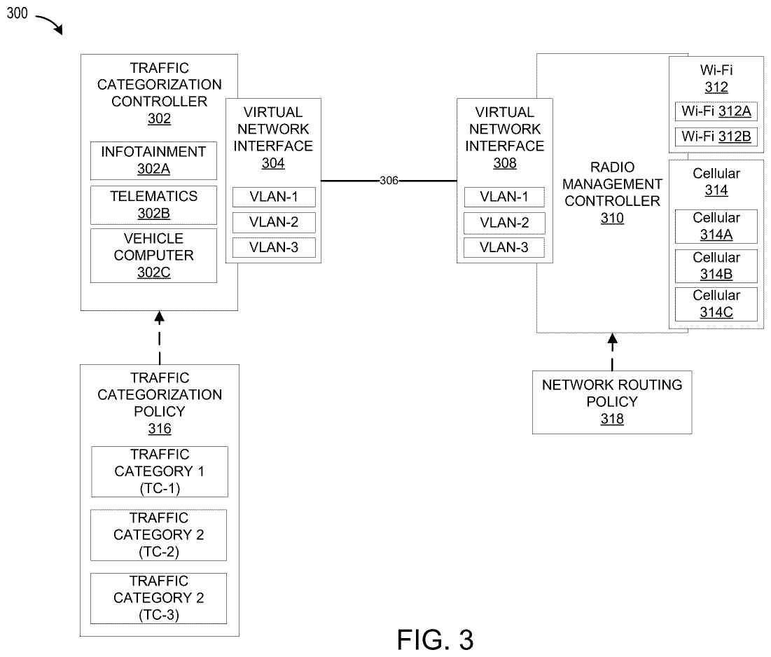

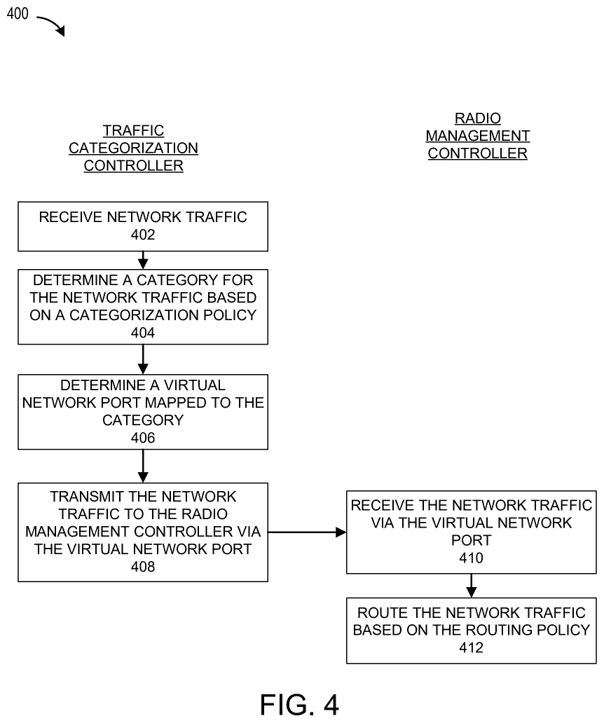

A control system 206 executes instructions to perform at least some of the actions or functions of the vehicle 100, including the functions described in relation to FIGS. 4 and 5. For example, as shown in FIG. 2, the control system 206 may include one or more electronic control units (ECUs) configured to perform at least some of the actions or functions of the vehicle 100, including the functions described in relation to FIGS. 3 and 4. In certain embodiments, each of the ECUs is dedicated to a specific set of functions. Each ECU may be a computer system and each ECU may include functionality described below in relation to FIGS. 3 and 4.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality. In some aspects, the TCM ECU may be distributed between multiple components that are implemented, in whole or in part, on a virtual machine.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described in relation to FIGS. 3 and 4.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

Referring to FIG. 3, a connectivity architecture 300 is shown. The connectivity architecture 300 includes a traffic categorization controller (TCC) 302 and a radio management controller (RMC) 310. In certain aspects, the TCC 302 and the RMC 310 are physically segregated from each other as a result of being implemented on separate hardware components within the vehicle 100 (e.g., on different ECUs or other vehicle systems). In certain aspects, the RMC 310 may be co-located with, and/or may include, wireless radios that enable connectivity to an external network, such as one or more Wi-Fi and/or cellular networks. More particularly, the RMC 310 may be located in proximity to an antenna, for example, in or on a roof of the vehicle 100. As shown, the TCC 302 and the RMC 310 are operable to communicate over an internal network connection 306. The internal network connection 306 may include one or more wired and/or wireless connections. In some aspects, the TCC 302 and the RMC 310 can represent a distribution of all or part of the TCM ECU shown in FIG. 2A.

The TCC 302 and the RMC 310 implement a virtual network interface (VNI) 304 and a VNI 308, respectively. The VNI 304 and the VNI 308 each include a corresponding set of virtual network ports, or virtual local area networks (VLANs), for example, VLAN-1, VLAN-2, VLAN-3. As will be further described below, VLAN-1, VLAN-2, and VLAN-3 can map to different categories of network traffic, resulting in the network traffic receiving variable treatment by the RMC 310.

In the example of FIG. 3, the TCC 302 includes an infotainment component 302A, a telematics component 302B, and a vehicle computer component 302C, each of which may be a source and/or target of network traffic for one or more applications in the vehicle 100. In an example, the infotainment component 302A can produce, or be a receiver for, network traffic related to navigation systems, video streaming, in-vehicle Wi-Fi hotspots, etc. In another example, the telematics component 302B can produce, or be a receiver for, network traffic related to a location, status, or behavior of the vehicle 100 (e.g., global navigation satellite system (GNSS) data, vehicle sensor data, etc.). In another example, the vehicle computer component 302C can include, or be a receiver for, network traffic related to vehicle performance, safety, maintenance, etc.

The foregoing components of the TCC 302 may refer to separate subsystems of the TCC 302, or alternatively, to separate systems that collectively form the TCC 302. In addition, it should be appreciated that the TCC 302 can include more, fewer, and/or different components that may serve as sources and/or targets of network traffic in the vehicle 100. For example, similar network traffic can be produced and/or received by different combinations of components than those shown in FIG. 3. For ease of description, functionality may be periodically described relative to the TCC 302, with the understanding that, in each instance, such functionality may refer to the TCC 302 generally and/or to individual components of the TCC 302.

In certain aspects, the TCC 302, and/or the components of the TCC 302, can each be a virtual machine. The virtual machine can execute, for example, on physical resources of the control system 206 of FIG. 2A. In addition, or alternatively, the virtual machine can execute on physical resources of the XMM ECU shown in FIG. 2A. In addition, or alternatively, the virtual machine can execute on physical resources of any of the other ECUs shown in FIG. 2A. Although examples are provided herein in which the TCC 302 (and/or its components) are implemented by one or more virtual machines, it should be appreciated that, in various other implementations, the TCC 302 (and/or its components) can represent, for example, a physical computer system.

In general, the TCC 302 can categorize network traffic according to a traffic categorization policy 316. The traffic categorization policy 316 may be stored in memory in or accessible to the TCC 302. In an example, the traffic categorization policy 316 can specify that network traffic be categorized based on its source within the vehicle 100 (e.g., a vehicle component or application from which the traffic originated), type (e.g., protocol or format), target, and/or the like. For illustrative purposes, the traffic categorization policy 316 is shown to include traffic categories TC-1, TC-2, and TC-3, although it should be appreciated that the traffic categorization policy 316 can include two, three, four, five, or any other suitable number of categories for a given implementation.

In an example, the traffic categorization policy 316 can specify that network traffic from the infotainment component 302A, the telematics component 302B, and the vehicle computer component 302C be mapped to traffic categories TC-1, TC-2, and TC-3, respectively. In another example, the traffic categorization policy 316 can map network traffic related to individual applications, such as individual source applications for the infotainment component 302A, the telematics component 302B, and/or the vehicle computer component 302C, to specific traffic categories of the traffic categorization policy 316. Other examples of determining categories for network traffic will be apparent to one skilled in the art after a thorough review of the present disclosure

In certain aspects, each traffic category of the traffic categorization policy 316 can map to a virtual network port of the VNIs 304 and 308. For example, traffic categories TC-1, TC-2, and TC-3 can map to VLAN-1, VLAN-2, and VLAN-3, respectively. Other examples of mappings will be apparent to one skilled in the art after a thorough review of the present disclosure.

In general, the RMC 310 can route network traffic received via the VNI 308 to an external network, such as one or more Wi-Fi and/or cellular networks, according to a network routing policy 318. The network routing policy 318 may be stored in memory in or accessible to the RMC 310. In particular, the RMC 310 is shown as routing network traffic through a Wi-Fi network interface 312 and/or a cellular network interface 314. The Wi-Fi network interface 312 is shown as including virtual Wi-Fi ports 312A and 312B, while the cellular network interface 314 is shown as including virtual cellular ports 314A, 314B, and 314C. In certain aspects, the routing functionality of the RMC 310 can include dynamically allowing such traffic to be routed through a firewall in the vehicle 100 (e.g., creating rules, exceptions, etc.).

In some aspects, the virtual cellular ports 314A, 314B, and 314C can relate to the same cellular network, but can differentiate some aspect of the traffic transmitted therethrough. For example, the virtual cellular ports 314A and 314B can differentiate the parties responsible for the network traffic. Examples of responsible parties can include, for example, a vehicle owner, a vehicle manufacturer, a fleet manager, a driver or passenger, a third-party service provider, etc. In certain aspects, the virtual cellular ports 314A, 314B, and 314C can facilitate, for example, billing for use of the cellular network. For example, network traffic resulting from certain infotainment applications may be attributed to a driver or passenger, while network traffic resulting from certain telematics applications may be attributed to a vehicle manufacturer. In addition, or alternatively, the virtual cellular ports 314A and 314B can differentiate a quality of service to be achieved for the network traffic (e.g., due to responsible party, data source, data target, data type, etc.).

In similar fashion to the virtual cellular ports 314A, 314B, and 314C, the virtual Wi-Fi ports 312A and 312B can relate to the same Wi-Fi network but can differentiate some aspect of the traffic transmitted therethrough, such as the parties responsible for the network traffic, a quality of service related to the network traffic, etc.

In certain aspects, the network routing policy 318 can specify that network traffic be routed through the Wi-Fi network interface 312 or the cellular network interface 314 based on a virtual network port of the VNI 308 through which the network traffic is received. For example, the network routing policy 318 can specify one or more transmission rules. Such rules can include conditions such as whether Wi-Fi connectivity is currently available via the Wi-Fi network interface 312.

In an example, the network routing policy 318 can specify that, if the network traffic is received via a particular virtual network port of the VNI 308 (e.g., VLAN-1), and Wi-Fi connectivity is currently available via the Wi-Fi network interface 312, the network traffic should be routed through a particular virtual Wi-Fi port of the Wi-Fi network interface 312 (e.g., virtual Wi-Fi port 312A). The network routing policy 318 can further specify, for example, that if Wi-Fi connectivity is not currently available via the Wi-Fi network interface 312, the network traffic should be routed through a particular virtual cellular port (e.g., virtual cellular port 314A).

In another example, the network routing policy 318 can specify that, if the network traffic is received via a particular virtual network port of the VNI 308 (e.g., VLAN-3), and Wi-Fi connectivity is currently available via the Wi-Fi network interface 312, the network traffic should be routed through a particular virtual Wi-Fi port of the Wi-Fi network interface 312. Different from the example above, the network routing policy 318 can omit any allowance for, or disallow, transmission of the network traffic through the cellular network interface 314.

In another example, the network routing policy 318 can specify that, if the network traffic is received via a particular virtual network port of the VNI 308 (e.g., VLAN-2), the network traffic should be routed through a particular virtual cellular port (e.g., virtual cellular port 314B), regardless of whether Wi-Fi connectivity is available via the Wi-Fi network interface 312. In various aspects, each virtual network port of the VNIs 304 and 308 can correspond to particular virtual cellular port of the cellular network interface 314. Other examples of rules or conditions that may be specified in the network routing policy 318 will be apparent to one skilled in the art after a detailed review of the present disclosure.

In certain aspects, although the traffic categorization policy 316 and the network routing policy 318 are separately shown and described, each such policy can refer to a singular policy that is accessible to both the TCC 302 and the RMC 310 (e.g., stored in shared storage, stored separately by the TCC 302 and the RMC 310 and periodically synchronized, etc.).

In certain aspects, the TCC 302 can be aware of a current connectivity status of the Wi-Fi network interface 312 and/or the cellular network interface 314. In example, the RMC 310 can notify the TCC 302 of a current connectivity status of the Wi-Fi network interface 312 and/or the cellular network interface 314. In another example, the TCC 302 can request and receive such connectivity statuses from the RMC 310. The current connectivity status can indicate, for example, that connectivity is available, that no connectivity is available, etc.

In certain aspects, the TCC 302 can take action relative to the VNI 304 based on the current connectivity status of the Wi-Fi network interface 312 and/or the cellular network interface 314. For example, the TCC 302 can close a virtual network port of the VNI 304 during such time that no connectivity will be provided via that port. In an example, if VLAN-1 of the VNI 304 corresponds to network traffic that is only transmitted over Wi-Fi, and Wi-Fi connectivity is currently unavailable, the TCC 302 can close VLAN-1 (e.g., close a corresponding port or socket), thereby allowing an application from which the traffic originated to retry at a later time when connectivity is available. According to this example, V-LAN-1 can be reopened when the TCC 302 becomes aware that connectivity is again available.

FIG. 4 illustrates an example of a process 400 for utilizing the connectivity architecture 300 of FIG. 3. At block 402, the TCC 302 receives network traffic. At block 404, the TCC 302 determines a category for the network traffic based on the traffic categorization policy 316 (e.g., TC-1, TC-2, or TC-3). At block 406, the TCC 302 determines a virtual network port of the VNIs 304 and 308 for the determined category (e.g., VLAN-1, VLAN-2, or VLAN-3). In some aspects, categories can be mapped to virtual network ports in the traffic categorization policy 316.

At block 408, the TCC 302 transmits the network traffic to the RMC 310 via the determined virtual network port of the VNI 304. The network traffic can be transmitted, for example, over the internal network connection 306. At block 410, the RMC 310 receives the network traffic via the determined virtual network port of the VNI 308. At block 412, the RMC 301 routes the network traffic, for example, through the Wi-Fi network interface 312 or the cellular network interface 314 according to the network routing policy 318. In certain aspects, the routing functionality of the RMC 310 can include dynamically allowing the traffic to be routed through a firewall (e.g., creating rules, exceptions, etc.).

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

1. A system for routing vehicle network traffic to external networks, the system comprising:
a first computer in a vehicle, wherein the first computer is operable to:
receive network traffic related to a software application executing in the vehicle;
determine a category for the network traffic based on a traffic categorization policy;
determine a virtual network port of a virtual network interface for the determined category; and
transmit the network traffic, via the determined virtual network port, over an internal network connection in the vehicle; and
a second computer in the vehicle, wherein the second computer is communicably coupled to the first computer via the internal network connection and is operable to:
receive the network traffic, via the virtual network port, over the internal network connection; and
route the network traffic to an external network based on the virtual network port.

2. The system of claim 1, wherein:
the first computer comprises a virtual machine executing on physical resources thereof; and
the virtual machine performs the receiving of the network traffic, the determining of the category, the determining of the virtual network port, and the transmitting of the network traffic.

3. The system of claim 1, wherein:
the traffic categorization policy maps a plurality of network traffic sources in the vehicle to a plurality of traffic categories; and
the category of the network traffic is determined based on a source of the network traffic within the vehicle, the plurality of network traffic sources comprising the source of the network traffic.

4. The system of claim 3, wherein:
the plurality of network traffic sources comprise an infotainment component and a vehicle telematics component; and
the traffic categorization policy maps traffic from the infotainment component to a first traffic category of the plurality of traffic categories and traffic from the vehicle telematics component to a second traffic category of the plurality of traffic categories.

5. The system of claim 3, wherein:
the plurality of network traffic sources comprise a first infotainment software application and a second infotainment software application; and
the traffic categorization policy maps traffic from the first infotainment software application to a first traffic category of the plurality of traffic categories and traffic from the second infotainment software application to a second traffic category of the plurality of traffic categories.

6. The system of claim 3, wherein the plurality of traffic categories map to a plurality of virtual network ports of the virtual network interface, the plurality of virtual network ports comprising the determined virtual network port.

7. The system of claim 3, wherein the network traffic is routed to the external network based on a network routing policy, the network routing policy specifying whether the network traffic is routed through a Wi-Fi network interface or a cellular network interface based on the virtual network port.

8. The system of claim 7, wherein the network routing policy specifies whether the network traffic is routed through the Wi-Fi network interface or the cellular network interface further based on an availability of Wi-Fi connectivity via the Wi-Fi network interface.

9. The system of claim 7, wherein the routing comprises, responsive to determining that the virtual network port corresponds to a first virtual network port of the virtual network interface and that Wi-Fi connectivity is currently available via the Wi-Fi network interface, routing the network traffic to the external network through the Wi-Fi network interface.

10. The system of claim 7, wherein the routing comprises, responsive to determining that the virtual network port corresponds to a first virtual network port of the virtual network interface and that Wi-Fi connectivity is not currently available via the Wi-Fi network interface, routing the network traffic to the external network through the cellular network interface.

11. The system of claim 10, wherein:
the cellular network interface comprises a plurality of virtual cellular ports; and
the routing the network traffic to the external network through the cellular network interface comprises routing the network traffic through a virtual cellular port of the plurality of virtual cellular ports that corresponds to the determined virtual network port.

12. The system of claim 11, wherein the plurality of virtual cellular ports differentiate at least one of a responsible party for the network traffic or a quality of service to be achieved for the network traffic.

13. The system of claim 7, wherein the routing comprises, responsive to determining that the virtual network port corresponds to a first virtual network port of the virtual network interface and that Wi-Fi connectivity is not currently available via the Wi-Fi network interface, disallowing transmission of the network traffic through the cellular network interface.

14. The system of claim 7, wherein the routing comprises, responsive to determining that the virtual network port corresponds to a first virtual network port of the virtual network interface, routing the network traffic through the cellular network interface, regardless of whether Wi-Fi connectivity is available via the Wi-Fi network interface.

15. The system of claim 14, wherein the first computer is further operable to:
receive, from the second computer, a notification that no connectivity is available via the Wi-Fi network interface; and
close at least one virtual network port of the virtual network interface responsive to the notification.

16. The system of claim 7, wherein the traffic categorization policy and the network routing policy are included in a single policy.

17. The system of claim 1, wherein the routing comprises dynamically allowing the network traffic to be routed through a firewall in the vehicle.

18. The system of claim 1, wherein the internal network connection comprises a wired network connection.

19. The system of claim 1, wherein the external network comprises at least one of a Wi-Fi network or a cellular network.

20. A method for routing vehicle network traffic to external networks, the method comprising:
receiving, at a first computer in a vehicle, network traffic related to a software application executing in the vehicle;
determining, at the first computer, a category for the network traffic based on a traffic categorization policy;
determining, at the first computer, a virtual network port of a virtual network interface for the determined category;
transmit the network traffic, via the determined virtual network port, over an internal network connection in the vehicle;
at a second computer in the vehicle, receiving the network traffic, via the virtual network port, over the internal network connection; and
at the second computer, routing the network traffic to an external network based on the virtual network port.
